(19) United States
(12) Patent Application Publication
(10) Pub. No.: US 2014/0061118 A1
(43) Pub. Date: Mar. 6, 2014

(54) DEVICE FOR THE SOLID/LIQUID SEPARATION OF SUBSTANCE MIXTURES AND SUSPENSIONS

(71) Applicant: Albert BÄHR, Ottweiler (DE)

(72) Inventor: Albert BÄHR, Ottweiler (DE)

(21) Appl. No.: 13/975,948

(22) Filed: Aug. 26, 2013

(30) Foreign Application Priority Data
Aug. 29, 2012 (DE) 20 2012 008 238.8

(51) Int. Cl. B01D 29/52

(52) U.S. Cl. CPC B01D 29/52
USPC 210/340

(57) ABSTRACT

Device for the solid/liquid separation of substance mixtures and suspensions, comprising a feed and at least one feed-side vertical filtration chamber (2, 3), to the outlet of which at least one pump device (6) is connected for removing the thickened residual volume from the filtration chamber (2) and for generating a pump pressure, and the pump device (6) is connected by connecting lines (10) to one or more closed compacting pressure chambers (8), in which device two filtration chambers (2, 3) are provided in parallel and each connected individually by valve means to the feed on the inlet side and by the pump device (6) to one or more compacting pressure chambers (8) on the outlet side.

### PRIORITY CLAIM

This application claims the benefit of priority to German Utility Model No. 202012008238.8, filed on Aug. 29, 2012.

### FIELD OF APPLICATION

The present invention relates to a device for the solid/liquid separation of sub-stance mixtures and suspensions.

A generic device of this type is already known from DE 10 2008 047 427.4, which discloses a device for the solid/liquid separation of substance mixtures and suspensions, comprising a feed and a feed-side vertical filtration chamber, to the outlet of which at least one pump device is connected for removing the thickened residual volume from the filtration chamber and for generating a pump pressure, the pump device being connected by connecting lines to one or more closed compacting pressure chambers.

The generic device indeed makes it possible to run a virtually pseudo-continuous operation, since the filtration chamber is almost permanently ready to take up substance mixtures to be separated. Nevertheless, in the prior art, an interruption to the supply or a temporary store are necessary, since the filtration chamber has to be emptied and cleaned on a regular basis.

On this basis, the object of the present invention is to develop a generic device for the solid/liquid separation of substance mixtures in such a way as to render possible an entirely continuous take-up of the substance mixtures or suspensions to be separated.

This object is achieved according to the invention by a generic device for the solid/liquid separation of substance mixtures and suspensions, in which two filtration chambers are provided in parallel and connected individually by valve means to the feed on the inlet side and by the pump device to one or more compacting pressure chambers on the outlet side.

In this manner, the invention makes it possible for the first time for such a device for the solid/liquid separation of substance mixtures and suspensions to be operated entirely continuously, that is, without interruption.

The invention will be described in detail in the following, with reference to the embodiment shown in the appended drawings, in which:

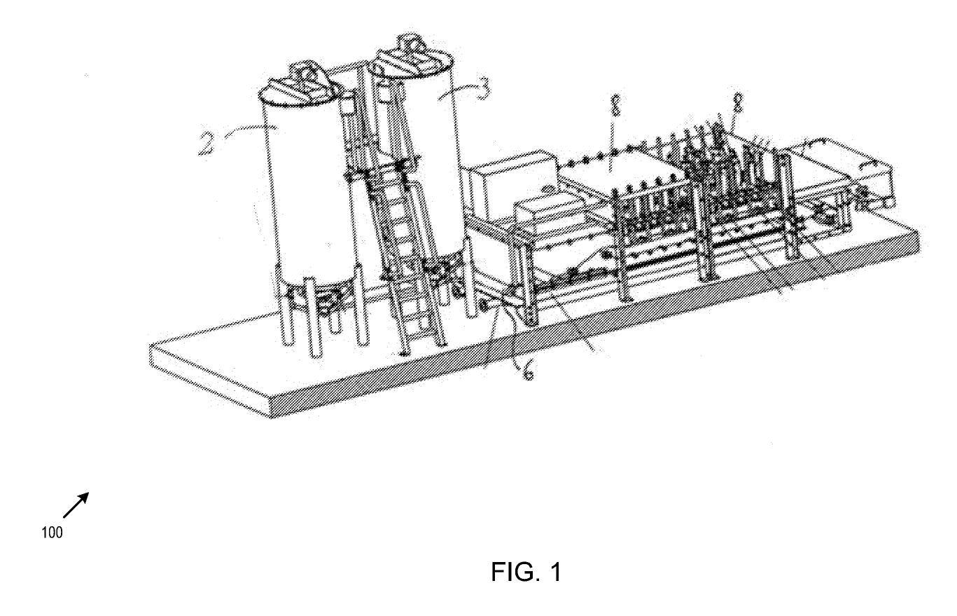

FIG. 1 is a front view of a device according to the invention for the solid/liquid separation of substance mixtures and suspensions, one of the compacting pressure chambers being open; and

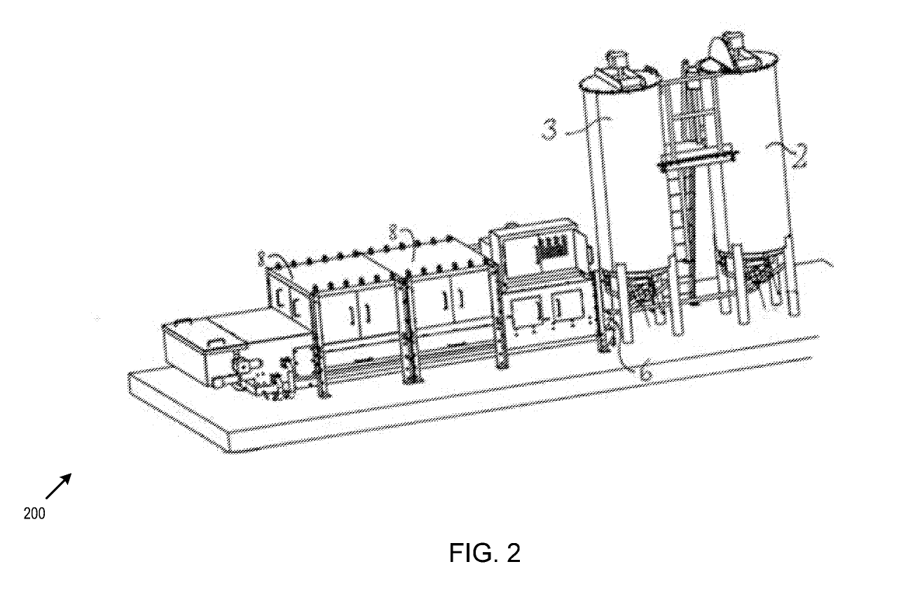

FIG. 2 shows the solid/liquid separation of substance mixtures and suspensions according to FIG. 1 from the opposite side (rear view).

FIG. 1 is a front view of a device according to the invention for the solid/liquid separation of substance mixtures and suspensions. The two filtration chambers 2, 3, the eccentric screw pump 6 and the compacting pressure chambers 8 can be identified from left to right.

The high-pressure filter press 10 according to the invention has two vertical filtration chambers 2, 3, and 1 to 8 horizontal compacting pressure chambers 8. Throughout the operating time, the suspension is fed alternatingly into the filtration chambers 2, 3 on a continuous basis without interruption and the filter cake is discharged from the compacting pressure chambers 8 at 3 to 12 minute intervals.

Drainage begins with the feed into the filtration chambers 2, 3 and is continued without interruption at increasing pressure into the compacting pressure chambers 8. Drainage times and pressure in the filtration and compacting pressure chambers are modified and adapted according to the drainage properties of the suspension. The drainage time in the filtration chambers is 60 minutes, the hydrostatic drainage pressure is, depending on the fill level, up to 0.4 bar. The drainage is activated using strippers and contact brushes. After 60 minutes of drainage time in the filtration chamber, a controllable eccentric screw pump 6 urges the thickened suspension into the compacting pressure chambers 8 in a pulsed manner. The pump pressure is 1 to 2 bar, the pressure dwell 1 to 2 minutes. Every 60 minutes, the feed into the filtration chambers 2, 3 switches. The filter cloth of the inactive chamber is washed using wash-water blast connections on either side.

Each compacting pressure chamber 8 is a complete module. Up to 8 modules are arranged horizontally in a row and have a common filter strip. The simultaneous opening and closing movement of the chambers for filter cake discharge is only 100 mm and lasts for 20 seconds. The filter strip discharges the filter cake horizontally and is washed simultaneously on either side. All movements of the compacting pressure chambers 8—opening, closing, tightening and drainage compacting pressure—take place by means of hydraulic cylinders.

There is no limit to the operating time of the high-pressure filter press:
continuous feed without interruption;
filter cake discharge every 3 to 12 minutes.

Specific drainage sequence:
60 minutes: filtration chamber having hydro-static pressure of up to 0.4 bar;
1 to 2 minutes: compacting pressure chamber having pump pressure of 1 to 2 bar;
5 to 10 minutes: compacting pressure chamber having a steel-plate compacting pressure of up to 40 bar;
66 to 72 minutes: total drainage time.

Sold/liquid separation depends on pressure and time. In principle, the aim, starting with a suspension, is to separate the liquid phase and the solid phase.

Solid/liquid filtration is a method of crucial significance in many industrial processes. The object of each process determines both the optimum selection of the filtration method and the plant engineering arrangement. Precisely in the field of the recovery of products and valuable substances, requirements in relation to selectivity and throughput become ever more stringent, with simultaneously higher operational reliability.

The solid/liquid content of suspensions varies greatly and determines the procedures of the machines for solid/liquid separation.

Filter presses are systems for solid/liquid separation. If a suspension flows against a textile fabric (filter cloth) which is permeable only to liquids, solids are obstructed at this textile fabric. As time passes, a filter cake forms on the filter cloth from the filtered-out solids. The liquid content of the suspension penetrates through the filter cloth and is recovered as a solid-free filtrate. The filter cloth and filter cake form an obstruction to the flow. As the filter cake builds up, ever greater pressure is needed to overcome this obstruction.

The arrangement, according to the invention, of 2 filtration chambers into which the suspension is fed alternatingly over the course of an operating time of 10 hours, for example, without interruption, allows simultaneous drainage in the filtration and compacting pressure chambers.

The solid/liquid content of suspensions varies greatly; the solid content is mostly below 10%, is of the mineral, organic or mixed type and has varying particle sizes. Accordingly, compressibility varies. The solid concentration of the suspension should be raised as quickly as possible under increasing pressure. Only a compact solid layer can be processed further under high compacting pressure.

In all chamber and membrane filter presses known to date, this step—filtration and subsequent compacting pressure—takes place in a single chamber.

The filter press according to the invention operates with separate chambers: a specific filtration chamber and a specific compacting pressure chamber. The filtration chamber operates at lower pressure for a long period. There is then a transition into the compacting pressure chamber under increasing pump pressure. The compacting pressure chamber operates at higher pressure and for a short period.

The filter press according to the invention allows, for the first time, the following operation sequence to be performed:

Upon operational start-up, filtration chamber 2 is first fed into on a continuous basis. After 60 minutes of feed, there is a switchover into filtration chamber 3. Over the course of the continuous feed into filtration chamber 3, there is pulsed removal from filtration chamber 2 and pump-pressure feed into the compacting chambers. Alternatingly, one filtration chamber is always being fed into and there is removal from the other filtration chamber in a pulsed manner and the compacting chambers are fed into discontinuously under pump pressure.

The operational sequence which has been made possible for the first time by means of the present invention can therefore be set out in terms of its chronology in the following table:

| | | Second | |
|---|---|---|---|
| | First filtration | filtration | Compacting pressure |
| h | chamber | chamber | chambers |
| 1 | Feed | — | — |
| | Drainage | | |
| 2 | Pulsed removal | Feed | Pulsed feed |
| | Drainage | Drainage | Drainage |
| | | | Pulsed discharge of filter cake |
| 3 | Feed | Pulsed removal | Pulsed feed |
| | Drainage | Drainage | Drainage |
| | | | Pulsed discharge of filter cake |
| 4 | Pulsed removal | Feed | Pulsed feed |
| | Drainage | Drainage | Drainage |
| | | | Pulsed discharge of filter cake |
| 5 | Feed | Pulsed removal | Pulsed feed |
| | Drainage | Drainage | Drainage |
| | | | Pulsed discharge of filter cake |
| 6 | Pulsed removal | Feed | Pulsed feed |
| | Drainage | Drainage | Drainage |
| | | | Pulsed discharge of filter cake |
| 7 | Feed | Pulsed removal | Pulsed feed |
| | Drainage | Drainage | Drainage |
| | | | Pulsed discharge of filter cake |
| 8 | Pulsed removal | Feed | Pulsed feed |
| | Drainage | Drainage | Drainage |
| | | | Pulsed discharge of filter cake |
| 9 | Feed | Pulsed removal | Pulsed feed |
| | Drainage | Drainage | Drainage |
| | | | Pulsed discharge of filter cake |
| 10 | Pulsed removal | — | Pulsed feed |
| | Drainage | | Drainage |
| | | | Pulsed discharge of filter cake |

1. Device for the solid/liquid separation of substance mixtures and suspensions, comprising a feed and at least one feed-side vertical filtration chamber (2, 3), to the outlet of which at least one pump device (6) is connected for removing the thickened residual volume from the filtration chamber (2) and for generating a pump pressure, the pump device (6) being connected by connecting lines (10) to one or more closed compacting pressure chambers (8), characterised in that two filtration chambers (2, 3) are provided in parallel and each connected individually by valve means to the feed on the inlet side and by the pump device (6) to one or more compacting pressure chambers (8) on the outlet side.
